(19) United States
(12) Patent Application Publication
(10) Pub. No.: US 2021/0367811 A1
(43) Pub. Date: Nov. 25, 2021

(54) GATEWAY DEVICE, COMMUNICATION SYSTEM, AND AUTOMATED WAREHOUSE SYSTEM

(71) Applicant: MURATA MACHINERY, LTD., kyoto-shi, Kyoto (JP)

(72) Inventor: Yoshifumi TANIMOTO, Kyoto (JP)

(21) Appl. No.: 16/968,173

(22) PCT Filed: Feb. 4, 2019
(86) PCT No.: PCT/JP2019/003904

§ 371 Date: Aug. 7, 2020

(30) Foreign Application Priority Data
Feb. 27, 2018 (JP) 2018-033013

(51) Int. Cl. H04L 12/66; H04L 12/24; H04L 29/08

(52) U.S. Cl. CPC H04L 12/66; H04L 67/141; H04L 41/12

(57) ABSTRACT

A first gateway device and a second gateway device each includes a network interface, a storage device, and a controller. The network interface is connected to an apparatus to perform communication with the apparatus and external communication. The storage device stores a first apparatus list and/or a second apparatus list. In response to receiving a connection request to the apparatus, the controller sends the connection request to the apparatus. In response to receiving a connection request to itself, the controller exchanges the first apparatus list and the second apparatus list with the other gateway device. In response to receiving data directed to an address included in the apparatus list, the controller transfers the received data to the apparatus assigned with the address.

### BACKGROUND OF THE INVENTION

### 1. Field of the Invention

The present invention relates to a gateway device connected to an apparatus included in a system to control communication between the apparatus and an external terminal, a communication system including a gateway device connected to an apparatus, and an automated warehouse system including a gateway device connected to an automated warehouse and an apparatus that monitors the automated warehouse.

### 2. Description of the Related Art

Conventionally, there is known a gateway device connected to an apparatus included in a predetermined system to control communication between the apparatus and an external terminal or the like. For example, JP-A-2017-4418 teaches a gateway device connected to a plurality of multi-functional peripherals (MFPs) in a LAN, to control communication between the MFP and an external management server and/or a cloud server.

In the conventional system described above, a communication session is established between the gateway and the external server (the management server or the cloud server), and through this communication session, transmission and reception of data to and from the MFP are performed only via the gateway. In other words, in the conventional system, a direct communication session cannot be established between the apparatus, for example, the MFP connected to the gateway and the external server and/or terminal. Consequently, communication between the apparatus connected to the gateway and the external terminal cannot be performed efficiently.

### SUMMARY OF THE INVENTION

Preferred embodiments of the present invention provide gateway devices each connected to an apparatus to perform efficient communication between the apparatus and an external terminal or the like.

A plurality of preferred embodiments of the present invention are described below. The preferred embodiments of the present invention are able to be combined with and/or modified in view of one another.

A gateway device according to a preferred embodiment of the present invention is a gateway device in a communication system including an apparatus with a predetermined operation and an external terminal to operate the apparatus, and to control communication between the apparatus and the external terminal. The gateway device includes a network interface, a storage device, and a controller. The network interface is connected to the apparatus to perform communication with the apparatus and external communication. The storage device stores address information. In the address information, an apparatus ID of the apparatus and an address assigned to the apparatus are stored in association with each other.

The controller, in response to receiving a connection request to the apparatus identified by the apparatus ID from a first external terminal via the network interface, sends the connection request to the apparatus.

On the other hand, the controller, in response to receiving a connection request to itself (the gateway device) from a second external terminal via the network interface, exchanges the address information with the second external terminal. The controller, in response to receiving data directed to an address included in the address information from the second external terminal, transfers the received data to the apparatus assigned with the address.

When the gateway device described above receives a connection request to the apparatus identified by the apparatus ID from the first external terminal via the network interface, the gateway device sends the connection request to the apparatus. Accordingly, the apparatus connected to the network interface of the gateway device and the first external terminal that has sent the connection request are able directly send and receive data with one another.

On the other hand, when the gateway device receives a connection request to the gateway device from the second external terminal via the network interface, the gateway device exchanges the address information with the second external terminal. Accordingly, the second external terminal is able to determine the address of the apparatus connected to the gateway device. As a result, the second external terminal is able to communicate with the apparatus connected to the gateway using the address included in the address information.

After exchanging the address information, when the second external terminal sends data directed to an address included in the address information to the gateway device, the gateway device that has received the data transfers the received data to the apparatus with which the address of a destination is assigned. Accordingly, also when a connection request is transmitted to the gateway device, the apparatus connected to the network interface of the gateway device and the second external terminal that has sent this connection request are able to send and receive the data with one another.

The connection request to the apparatus identified by the apparatus ID may be a log-in request signal that controls the apparatus to log in to the relay server. The relay server is included in the communication system and establishes a communication session between the logged-in apparatus and the first external terminal. Thus, in response to receiving the log-in request signal, the controller controls the identified apparatus to log in to the relay server.

Accordingly, in response to receiving the connection request to the apparatus connected to the network interface from the first external terminal, when the apparatus is not logged in to the relay server, the gateway device is able to control the apparatus to log in to the relay server.

If the identified apparatus is unable to communicate when the controller receives the log-in request signal, the controller may attempt to activate the identified apparatus, and control the identified apparatus to log in to the relay server after the identified apparatus is activated.

Accordingly, when the connection request to the apparatus is sent from the first external terminal, even if the apparatus is unable to communicate, the first external terminal and the apparatus are able start communication between the first external terminal and the apparatus.

The controller may monitor a connection status of the apparatus to the network interface, and when the connection status of the apparatus has changed, the controller may transmit, to the relay server, information regarding the change in the connection status. Accordingly, the relay server is able to be informed of the most recent connection status of the apparatus connected to the network interface.

A communication system according to another preferred embodiment of the present invention includes an apparatus with a predetermined operation, an external terminal to operate the apparatus, and a first gateway device to connect to the apparatus.

The first gateway device includes a network interface, a storage device, and a controller. The network interface is connected to the apparatus to perform communication with the apparatus and external communication. The storage device stores first address information, in which an apparatus ID of the apparatus and an address assigned to the apparatus are stored in association with each other.

The controller, in response to receiving a request to connect to the apparatus identified by the apparatus ID from the external terminal via the network interface, sends the connection request to the apparatus.

In the communication system described above, when a connection request to the apparatus identified by the apparatus ID of the apparatus connected to the network interface is sent from the external terminal via the network interface of the first gateway device, the connection request is sent to the apparatus.

Accordingly, the apparatus connected to the network interface of the first gateway device and the first external terminal that has sent the connection request can directly send and receive data to and from each other.

The communication system described above may further include a relay server. The relay server establishes a communication session between the logged-in apparatus and the external terminal. Further, the connection request to the apparatus identified by the apparatus ID may be a log-in request signal that controls the apparatus to log in to the relay server. Thus, in response to receiving the log-in request signal, the controller controls the identified apparatus to log in to the relay server.

Accordingly, when the connection request to the apparatus connected to the network interface is received from the first external terminal, when the apparatus is not logged in to the relay server, the first gateway device of the communication system is able to control the apparatus to log in to the relay server.

If the identified apparatus is unable to communicate when the controller receives the log-in request signal, the controller may attempt to activate the identified apparatus, and control the identified apparatus to log in to the relay server after the identified apparatus is activated.

Accordingly, when the connection request to the apparatus is sent from the first external terminal, even if the apparatus is unable to communicate, the first external terminal and the apparatus are able to start communication with each other.

The controller may monitor a connection status of the apparatus to the network interface, and when the connection status of the apparatus has changed, the controller may transmit, to the relay server, information regarding the change in the connection status.

Accordingly, in the communication system, the relay server is able to be informed of the most recent connection status of the apparatus connected to the network interface.

The communication system described above may further include a second gateway device. The second gateway device is connected to a maintenance terminal to perform maintenance of the apparatus.

Thus, in response to receiving a connection request to the first gateway device from the maintenance terminal via the second gateway device, the controller exchanges the first address information with the second gateway device. Further, in response to receiving data directed to an address included in the first address information from the maintenance terminal via the second gateway device, the controller transfers the received data to the apparatus assigned with the address.

When the connection request to the first gateway device is sent from the maintenance terminal via the second gateway device, the first address information is exchanged with the second gateway device, and hence the second gateway device and the maintenance terminal are able to determine the address of the apparatus connected to the first gateway device.

As a result, the second gateway device and the maintenance terminal are able to communicate with the apparatus connected to the first gateway device using the address included in the first address information.

The second gateway device may store the second address information including the address assigned to the maintenance terminal. Thus, when the second gateway device exchanges the first address information with the first gateway device, the second gateway device may exchange the second address information with the first gateway device.

Accordingly, the first gateway device and the apparatus are able to determine the address of the maintenance terminal included in the second address information. As a result, the first gateway device and the apparatus are able to communicate with the maintenance terminal using the address included in the second address information.

The communication system described above may further include an automated warehouse. The automated warehouse loads and unloads, transfers, and stores parcels. Thus, the apparatus is a monitoring apparatus that is installed in the automated warehouse and that monitors a status of the automated warehouse.

Accordingly, the communication system described above may be applied to a system that monitors a status of the automated warehouse.

An automated warehouse system according to still another preferred embodiment of the present invention includes an automated warehouse, a monitoring apparatus, and a gateway device.

The automated warehouse loads and unloads, transfers, and stores parcels. The monitoring apparatus is installed in the automated warehouse and monitors a status of the automated warehouse. The gateway device is connected to the monitoring apparatus and includes a network interface, a storage device, and a controller.

The network interface is connected to the monitoring apparatus to perform communication with the monitoring apparatus and external communication. The storage device stores address information in which an apparatus ID of the monitoring apparatus and an address assigned to the monitoring apparatus are stored in association with each other.

The controller, in response to receiving a request to connect to the monitoring apparatus identified by the apparatus ID via the network interface, sends the connection request to the monitoring apparatus. Further, the controller, in response to receiving data directed to an address included in the address information, transfers the received data to the monitoring apparatus assigned with the address.

In the automated warehouse system described above, when a connection request to the monitoring apparatus identified by the apparatus ID is sent from an external terminal, the connection request is sent to the monitoring apparatus. Accordingly, the monitoring apparatus connected to the network interface of the gateway device and the external terminal that has sent the connection request are able to directly send and receive data with one another.

On the other hand, in response to receiving data directed to an address included in the address information from the external terminal, the apparatus connected to the gateway device and the external terminal are able to perform data communication with one another using the address included in the address information.

The gateway device described above provides an apparatus connected to itself and an external terminal that are able to perform direct communication with one another, and efficient communication is able to be performed between the apparatus and the external terminal.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing one example of an overall structure of a communication system.

FIG. 2 is a diagram showing a structure of an automated warehouse system.

FIG. 3 is a diagram showing a structure of a maintenance base.

FIG. 4 is a diagram showing a hardware structure of a gateway device.

FIG. 5A is a diagram showing one example of a data structure of an apparatus list managed by the gateway device in the automated warehouse system.

FIG. 5B is a diagram showing one example of a data structure of an apparatus list managed by the gateway device in the maintenance base.

FIG. 6 is a diagram showing one example of a data structure of an able-to-log-in apparatus list.

FIG. 7 is a flowchart showing an operation of establishing a communication session between a user terminal and a camera and/or sensor in the automated warehouse system.

FIG. 8 is a flowchart showing an operation of establishing a communication session between the gateway devices.

FIG. 9 is a flowchart showing an operation of generating and sending the able-to-log-in apparatus list.

FIG. 10 is a flowchart showing an operation of monitoring a connection status of the apparatus.

### DETAILED DESCRIPTION OF THE PREFERRED EMBODIMENTS

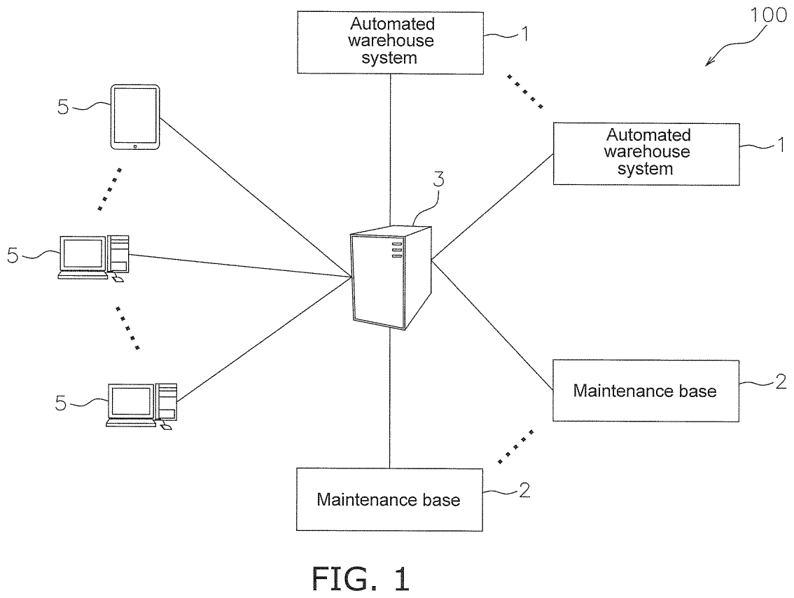

Hereinafter, an overall structure of a communication system 100 according to a first preferred embodiment of the present invention is described, referring to FIG. 1. FIG. 1 is a diagram showing one example of the overall structure of the communication system.

The communication system 100 according to the first preferred embodiment is a system to maintain and manage an automated warehouse installed in each of a plurality of locations, through various terminals. Specifically, the communication system 100 includes automated warehouse systems 1, maintenance bases 2, a relay server 3, and user terminals 5.

The automated warehouse system 1 is installed in a distribution center or the like, for example, and is a system to load and unload parcels.

The maintenance base 2 is installed in a base in which a person in charge of maintenance of the automated warehouse system 1 exists, for example, and includes a terminal that maintains the automated warehouse system 1 (maintenance terminal 21a, 21b).

The relay server 3 is a computer system including a central processing unit (CPU), a storage device (for example, a RAM, a ROM, an SSD, or a hard disk drive), and various interfaces for example, a network interface, and is a server to relay and manage communication among the automated warehouse systems 1, the maintenance bases 2, and/or the user terminals 5.

The relay server 3 establishes a communication session among the plurality of apparatuses logged in to the relay server 3, and relays communication among the plurality of apparatuses. In the first preferred embodiment, the apparatuses that are able to log in to the relay server 3 are the user terminal 5, the gateway devices in the automated warehouse system 1 and the maintenance base 2, and cameras CA1 to CA4 and a sensor SE in the automated warehouse system 1.

The relay server 3 receives a list of apparatuses that are able to log in to the relay server 3 among apparatuses connected to a gateway device in the automated warehouse system 1 (referred to as an “able-to-log-in apparatus list EL3”) from the gateway device, and stores the list.

Further, when the gateway device transmits information that a connection status of an apparatus included in the able-to-log-in apparatus list EL3 has changed, the relay server 3 updates the able-to-log-in apparatus list EL3 managed by the relay server 3.

Further, if one of the apparatuses for which a communication session should be established is not logged in to the relay server 3, the relay server 3 sends a signal that controls the apparatus to log in (referred to as a “log-in request signal”) to the gateway device connected to the apparatus that is not logged in.

The user terminal 5 (one example of a first external terminal) is a terminal, for example, a personal computer or a tablet terminal.

The user terminal 5 that is logged in to the relay server 3 is able to access to image data taken by the camera CA1 to CA4 (described later) installed in the automated warehouse system 1, and measurement data acquired by the sensor SE. Further, the user terminal 5 that is logged in to the relay server 3 is able to perform video chat communication with another user terminal 5.

It should be noted that, in the communication system 100 according to the first preferred embodiment, transmission and reception of a command among the user terminal 5, the gateway device described later, the camera and the sensor in the automated warehouse system 1, and the relay server 3 are performed using WebSocket protocol, for example.

Further, after establishing a communication session between the user terminal 5 and the camera or the sensor in the automated warehouse system 1, the user terminal 5 acquires data (image data or measurement data) from the camera or the sensor using WebRTC (Web Real-Time Communication), for example.

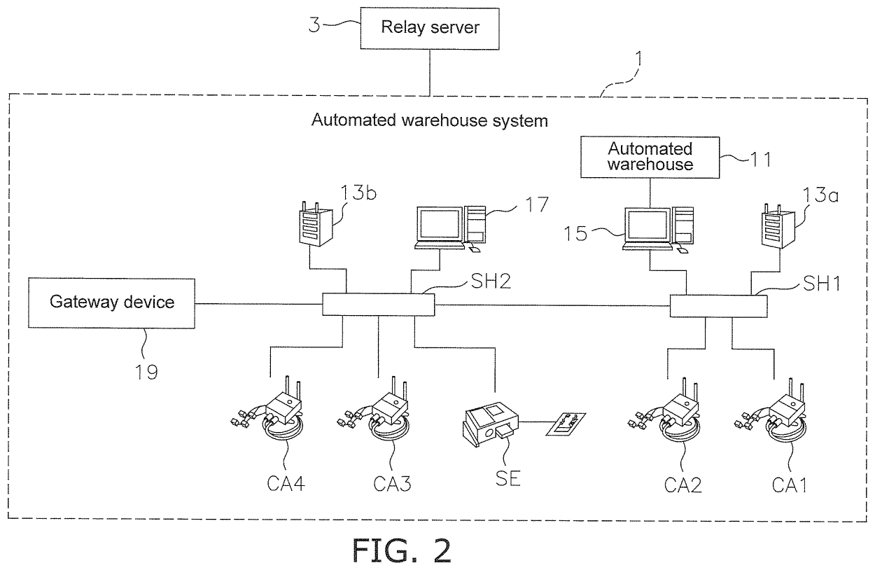

Hereinafter, a specific structure of the automated warehouse system 1 included in the communication system 100 is described, referring to FIG. 2. FIG. 2 is a diagram showing a structure of the automated warehouse system.

The automated warehouse system 1 includes an automated warehouse 11. The automated warehouse 11 includes racks, stacker cranes, conveyors, and the like, to load, unload, transfer, and store parcels.

In the first preferred embodiment, the stacker crane and the conveyor in the automated warehouse 11 are equipped with the cameras CA1 to CA4 (one example of a monitoring apparatus) that are able to take a still image and a moving image of a predetermined time length, for example, to determine statuses of the stacker crane and the conveyor as visual information. The cameras CA1 to CA4 are fish-eye cameras, for example.

Further, the stacker crane is equipped with the sensor SE that is able to measure a predetermined physical quantity (one example of a monitoring apparatus), and a level of vibration and/or sound generated by a collapse of parcels or the like is able to be measured when the collapse of parcels occurs in the stacker crane. An acceleration sensor, a sound sensor, or the like may be included as this sensor SE, for example.

Furthermore, a sensor SE that is able to measure ambient temperature and humidity (for example, a temperature and humidity sensor) is located adjacent to or in a vicinity of the automated warehouse 11.

It should be noted that the automated warehouse system 1 shown in FIG. 2 is equipped with four cameras CA1 to CA4 and one sensor SE, but the number of cameras and sensors installed in the automated warehouse 11 is not limited to this example and may be any number in accordance with a scale or the like of the automated warehouse system 1.

Hereinafter, a network structure in which the apparatuses in the automated warehouse system 1 communicate with each other is described.

The network structure of the automated warehouse system 1 includes a first switching hub SH1. The first switching hub SH1 connects the cameras CA1 and CA2 to a first external storage device 13a as shown in FIG. 2. The first external storage device 13a is a network attached storage (NAS) device, for example, and stores image data acquired by the cameras CA1, CA2.

Further, the first switching hub SH1 connects a conveyance management server 15. The conveyance management server 15 is a computer system including a CPU, a storage device (for example, a RAM, a ROM, an SSD, or a hard disk drive), and various interfaces, for example, a network interface, and is able to communicate with the stacker crane, the conveyor, and the like in the automated warehouse 11.

The conveyance management server 15 controls the stacker crane and the conveyor provided to the automated warehouse 11, thus controls and manages loading and unloading of parcels in the automated warehouse 11.

The network structure of the automated warehouse system 1 includes a second switching hub SH2. The second switching hub SH2 connects the cameras CA3 and CA4, the sensor SE, and a second external storage device 13b. The second external storage device 13b is a NAS device, for example, and stores image data acquired by the cameras CA3, CA4 and measurement data acquired by the sensor SE.

The second switching hub SH2 is also connected to the first switching hub SH1, and the image data acquired by the cameras CA1, CA2 is also able to be stored in the second external storage device 13b, and the image data acquired by the cameras CA3, CA4 and the data acquired by the sensor SE is also able to be stored in the first external storage device 13a.

Further, the second switching hub SH2 connects an information management server 17. The information management server 17 is a computer system including a CPU, a storage device (for example, a RAM, a ROM, an SSD, or a hard disk drive), and various interfaces, for example, a network interface, and manages various data stored in the first external storage device 13a and the second external storage device 13b (for example, data acquired by the cameras CA1 to CA4 and the sensor SE). The information management server 17 receives information managed by the conveyance management server 15.

The network structure of the automated warehouse system 1 includes a first gateway device 19. The first gateway device 19 is connected to the second switching hub SH2, and an external network (for example, a wide area network (WAN)).

In response to receiving a log-in request signal that controls the camera CA1 to CA4 or the sensor SE to log in from the relay server 3, the first gateway device 19 controls the camera and/or sensor, which is requested to log in, to log in to the relay server 3.

On the other hand, when a connection request is transmitted from a gateway device (a second gateway device 23, for example) (one example of a second external terminal) in order to maintain the apparatus connected to the first gateway device 19 from the maintenance base 2, a communication session is established between the first gateway device 19 and the gateway device of this maintenance base 2.

Further, the first gateway device 19 manages the apparatuses that are included in the automated warehouse system 1 and connected to the first gateway device 19, using a first apparatus list EL1 described later (one example of first address information).

The first gateway device 19 checks connection status between the apparatus in the automated warehouse system 1 and the first gateway device 19, and when the connection status has changed, the first gateway device 19 updates the first apparatus list EL1. Accordingly, the first apparatus list EL1 is able to be a most recent list.

As described later, each of the apparatus included in the first apparatus list EL1 is assigned with an IP address of 192.168.0.*, and the first gateway device 19 belonging to the same LAN as the apparatuses is also assigned with an IP address of 192.168.0.*. The first gateway device 19 is also assigned with a global address to connect to the external network.

It should be noted that the symbol “*” is a “wild card” representing an arbitrary number (an integer between 1 and 255).

When the first gateway device 19 establishes a communication session with the gateway device of the maintenance base 2, the first gateway device 19 sends the first apparatus list EL1 to the another gateway device with which the communication session is established, and receives an apparatus list managed by the another gateway device with which the communication session is established. Accordingly, the first gateway device 19 and the another gateway device are able to share the apparatus list with each other.

It should be noted that, in the network structure shown in FIG. 2, the cameras CA1 to CA4 and the sensor SE are able to directly communicate with the relay server 3. Thus, the first gateway device 19 may relay communication between the relay server 3 and the cameras CA1 to CA4 or the sensor SE, as a default gateway.

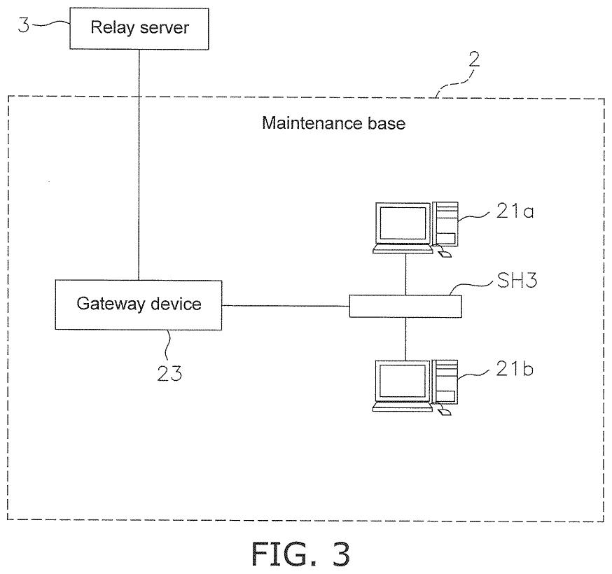

Hereinafter, a specific structure of the maintenance base 2 included in the communication system 100 is described, referring to FIG. 3. FIG. 3 is a diagram showing a structure of the maintenance base.

The maintenance base 2 includes maintenance terminals 21a and 21b. The maintenance terminals 21a, 21b are connected to a third switching hub SH3. The maintenance terminals 21a, 21b are a personal computer, for example, and are operated when a person in charge of maintenance performs maintenance of the apparatus of the automated warehouse system 1.

The maintenance base 2 includes a second gateway device 23. The second gateway device 23 is connected to the third switching hub SH3 and the external network, and relays communication between the maintenance terminals 21a, 21b and the external network.

The second gateway device 23 manages the maintenance terminals 21a, 21b that may connect to the second gateway device 23, using a second apparatus list EL2 (one example of second address information).

As described later, the maintenance terminals 21a, 21b included in the second apparatus list EL2 are assigned with an IP address of “172.28.0.*”, and the second gateway device 23 belonging to the same LAN as the maintenance terminals 21a, 21b is also assigned with an IP address of “172.28.0.*”. Concurrently, the second gateway device 23 is assigned with a global address to connect to the external network.

When performing maintenance of an apparatus of the automated warehouse system 1 using the maintenance terminals 21a, 21b, a communication session is established between the second gateway device 23 and the gateway device of the automated warehouse system 1 (e.g. the first gateway device 19).

When establishing the communication session as described above, the second gateway device 23 sends the second apparatus list EL2 to the another gateway device with which the communication session is established and receives the apparatus list managed by the another gateway device with which the communication session is established.

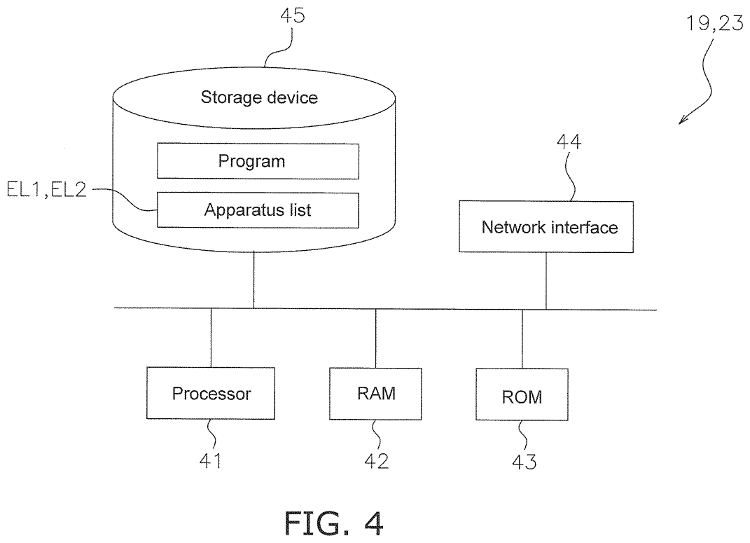

Hereinafter, a hardware structure of the gateway device according to the first preferred embodiment is described, referring to FIG. 4. FIG. 4 is a diagram showing a hardware structure of the gateway device.

It should be noted that the first gateway device 19 of the automated warehouse system 1 and the second gateway device 23 of the maintenance base 2 have the same or similar hardware structure except that the apparatus list managed by each gateway device is different. In other words, only the operations of the gateway devices are different depending on whether they are implemented in the automated warehouse system 1 or in the maintenance base, while they have the same or similar hardware structure.

The gateway device includes a processor 41, a RAM 42, a ROM 43, a network interface 44, and a storage device 45.

The processor 41 is a CPU or circuit, for example, which executes a program stored in the storage device 45 or the like to function as and define the gateway device. The RAM 42 stores temporary information, for example, a program. The ROM 43 stores a program and setting to control the gateway device.

The network interface 44 is an Ethernet (registered trademark) card that is connected to a LAN to which the gateway device belongs and the external network, and communicates with the terminal and/or the apparatus via wired communication, and/or a wireless LAN interface that is connected to a LAN to which the gateway device belongs and the external network, and communicates with the terminal and/or the apparatus via wireless communication.

The storage device 45 is a storage device, for example, a hard disk drive or an SSD, which stores a program executed by the gateway device, settings to operate the gateway device, the apparatus list, and the like.

The gateway device of the automated warehouse system 1 (e.g. the first gateway device 19) stores the apparatus list including information about each apparatus of the automated warehouse system 1 (e.g. the first apparatus list EL1) in the storage device 45.

On the other hand, the gateway device of the maintenance base 2 (e.g. the second gateway device 23) stores the apparatus list including information about the maintenance terminal (e.g. the second apparatus list EL2) in the storage device 45.

It should be noted that, while the gateway device of the automated warehouse system 1 and the gateway device of the maintenance base 2 have the same or similar hardware structure, the program stored in the storage device 45 functions as and defines both the gateway device of the automated warehouse system and as the gateway device of the maintenance base 2. The processor 41 executing the program is able to determine which one of the operations should be performed based on which apparatus is connected to the gateway device, and/or based on a content of the apparatus list managed by the gateway device, for example.

In another preferred embodiment of the present invention, the processor 41 and some of the hardware elements of the gateway device described above (for example, the network interface 44) may be implemented in a single chip as a system on chip (SoC).

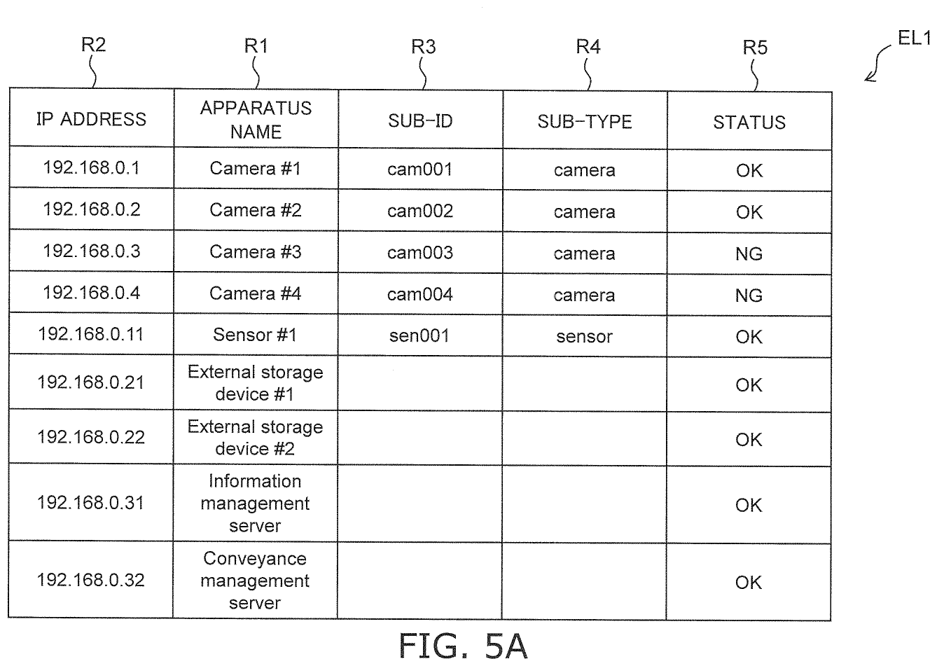

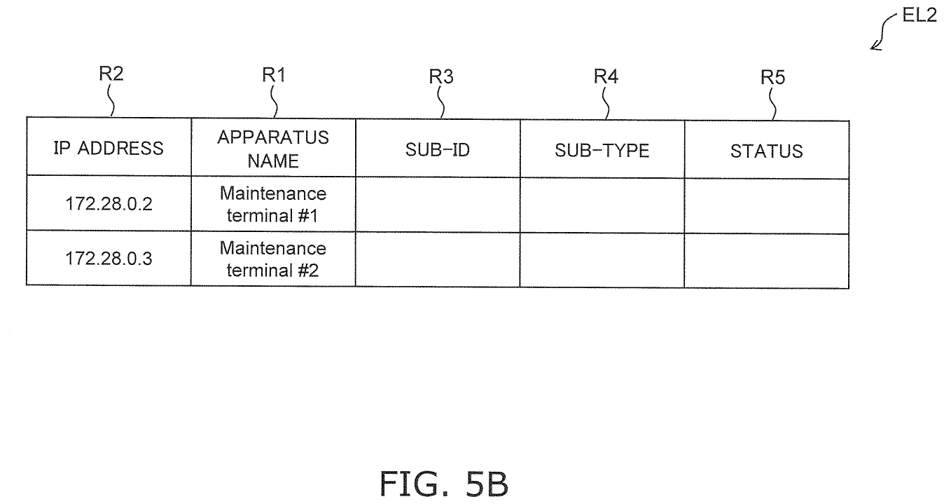

Hereinafter, a data structure of the apparatus list managed by the gateway device is described. Referring to FIG. 5A, a data structure of the apparatus list managed by the gateway device of the automated warehouse system 1 is first described with an example of the first apparatus list EL1 managed by the first gateway device 19. FIG. 5A is a diagram showing one example of the data structure of the apparatus list managed by the gateway device of the automated warehouse system.

The first apparatus list EL1 includes an apparatus name record portion R1, an address record portion R2, a sub-ID record portion R3, a sub-type record portion R4, and a status record portion R5.

The apparatus name record portion R1 records an apparatus name.

As shown in FIG. 5A, in the first apparatus list EL1 managed by the first gateway device 19, the apparatus name record portion R1 records names of the cameras CA1 to CA4 (camera #1 to camera #4), a name of the sensor SE (sensor #1), a name of the first external storage device 13a (external storage device #1), a name of the second external storage device 13b (external storage device #2), a name of the information management server 17 (information management server), and a name of the conveyance management server 15 (conveyance management server).

The address record portion R2 records a network address assigned to an apparatus that is able to connect to the gateway device.

As shown in FIG. 5A, in the first apparatus list EL1, the address record portion records IP addresses “192.168.0.1” to “192.168.0.4” in the rows of apparatus names “camera #1” to “camera #4”, respectively. Further, an IP address “192.168.0.11” is recorded in the rows of apparatus name “sensor #1”.

Furthermore, IP addresses “192.168.0.21” and “192.168.0.22” are recorded in the rows of apparatus names “external storage device #1” and “external storage device #2”, respectively.

Further, IP addresses “192.168.0.31” and “192.168.0.32” are recorded in the rows of apparatus names “information management server” and “conveyance management server”, respectively.

In other words, in the automated warehouse system 1 of the first preferred embodiment, the cameras CA1 to CA4 are assigned with IP addresses “192.168.0.1” to “192.168.0.4”, respectively, and the sensor SE is assigned with IP address “192.168.0.11”.

Further, the first external storage device 13a and the second external storage device 13b are assigned with IP addresses “192.168.0.21” and “192.168.0.22”, respectively, and the information management server 17 and the conveyance management server 15 are assigned with IP addresses “192.168.0.31” and “192.168.0.32”, respectively.

The sub-ID record portion R3 records a log-in ID (sub-ID) for the apparatus to log in to the relay server 3.

As shown in FIG. 5A, in the first apparatus list EL1, sub-IDs “cam001” to “cam004” are recorded in the rows of apparatus names “camera #1” to “camera #4” respectively, and sub-ID “sen001” is recorded in the row of apparatus name “sensor #1”.

In other words, the cameras CA1 to CA4 have IDs (sub-IDs) “cam001” to “cam004” to log in to the relay server 3 respectively, and the sensor SE has sub-ID “sen001”.

The sub-type record portion R4 records a user type (sub-type) identifying a type of the apparatus connected to the gateway device.

As shown in FIG. 5A, in the first apparatus list EL1, a sub-type “camera” is recorded in the rows of apparatus names “camera #1” to “camera #4”, and a sub-type “sensor” is recorded in the row of apparatus name “sensor #1”.

In other words, the cameras CA1 to CA4 have the same or similar sub-type “camera”, and the sensor SE has the sub-type “sensor”.

On the other hand, in the first apparatus list EL1, the sub-ID as well as the sub-type is not recorded in the rows of apparatus names “external storage device #1”, “external storage device #2”, “information management server”, and “conveyance management server”. Accordingly, the first external storage device 13a, the second external storage device 13b, the conveyance management server 15, and the information management server 17 of the automated warehouse system 1 are not assigned with the sub-ID or the sub-type and therefore are not able to log in to the relay server 3.

The status record portion R5 records whether or not each apparatus recorded in the apparatus list is able to communicate with the gateway device.

In the example of the first apparatus list EL1 shown in FIG. 5A, “NG” is recorded in the rows of apparatus names “camera #3” and “camera #4”, while “OK” is recorded in the other rows. In other words, in the example of the first apparatus list EL1 shown in FIG. 5A, the cameras CA3 and CA4 of the automated warehouse system 1 are unable to communicate with the first gateway device 19.

With the data structure described above, the apparatus list managed by the gateway device of the automated warehouse system 1 is able to record the sub-ID for the apparatus of the automated warehouse system 1 to log in to the relay server 3, a type (sub-type) of the apparatus, a connection status between each apparatus and the gateway device, and the like. Further, with respect to the apparatus list provided above, the address that is used when a communication session is established between the gateway devices is able to be managed.

Referring to FIG. 5B, a data structure of the apparatus list managed by the gateway device of the maintenance base 2 is described with an example of the second apparatus list EL2 managed by the second gateway device 23. FIG. 5B is a diagram showing one example of the data structure of the apparatus list managed by the gateway device of the maintenance base.

Similar to the first apparatus list EL1 described above, the second apparatus list EL2 includes the apparatus name record portion R1, the address record portion R2, the sub-ID record portion R3, the sub-type record portion R4, and the status record portion R5.

The apparatus name record portion R1 of the second apparatus list EL2 records names of the maintenance terminals connected to the gateway device, i.e. a name of the maintenance terminal 21a (maintenance terminal #1), and a name of the maintenance terminal 21b (maintenance terminal #2).

The address record portion R2 of the second apparatus list EL2 records IP addresses “172.28.0.2” and “172.28.0.3” in the rows of apparatus names “maintenance terminal #1” and “maintenance terminal #2”, respectively.

In other words, in the maintenance base 2 of the first preferred embodiment, the maintenance terminals 21a and 21b are assigned with IP addresses “172.28.0.2” and “172.28.0.3”, respectively.

As shown in FIG. 5B, unlike the first apparatus list EL1, the sub-ID record portion R3 of the second apparatus list EL2 does not record the sub-IDs of the maintenance terminals 21a and 21b. Accordingly, the maintenance terminals 21a and 21b included in the second apparatus list EL2 are not able to log in to the relay server 3.

Since the maintenance terminals 21a, 21b are not able to log in to the relay server 3, and therefore the sub-type of the maintenance terminals 21a, 21b does not need to be managed, no information is recorded also in the sub-type record portion R4 of the second apparatus list EL2.

Furthermore, the status record portion R5 of the second apparatus list EL2 also does not record information about whether the maintenance terminals 21a, 21b are able to communicate with the second gateway device 23 or not. As described herein, when the maintenance terminals 21a, 21b manage the apparatus of the automated warehouse system 1, the maintenance terminals 21a, 21b access to the second gateway device 23, and by this access a determination may be performed regarding whether or not the maintenance terminals 21a, 21b are able to communicate with the second gateway device 23.

With the data structure described above, the apparatus list may record the sub-ID of the apparatus connected to the gateway device to log in to the relay server 3, the type (sub-type) of the apparatus, the connection status between each apparatus and the gateway device, and the like. Further, the address that is used when a communication session is established between the gateway devices is able to be managed.

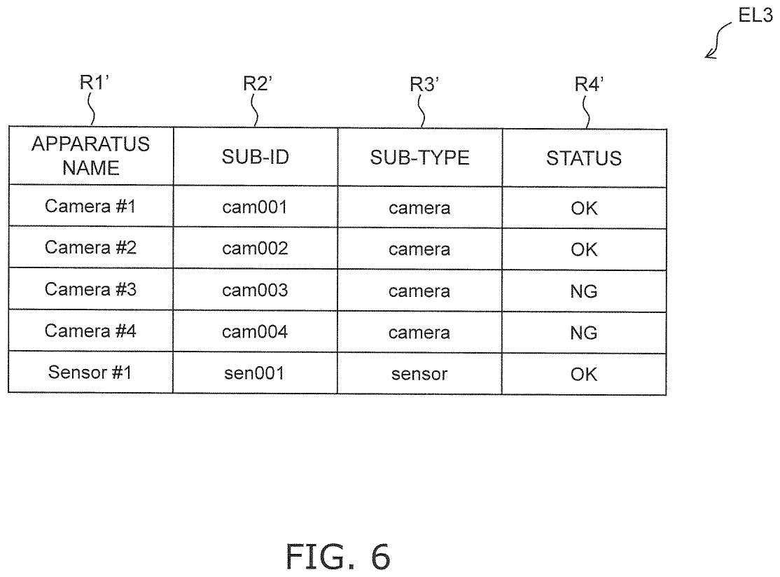

Next, referring to FIG. 6, a data structure of the able-to-log-in apparatus list EL3 managed by the relay server 3 is described. FIG. 6 is a diagram showing one example of a data structure of the able-to-log-in apparatus list.

The able-to-log-in apparatus list EL3 is generated by the gateway device included in the automated warehouse system 1 and is sent to the relay server 3. Therefore, each able-to-log-in apparatus list EL3 managed by the relay server 3 is associated with the user ID of the gateway device that generated the able-to-log-in apparatus list EL3.

The able-to-log-in apparatus list EL3 shown in FIG. 6 is generated by the first gateway device 19 of the automated warehouse system 1 and is sent to the relay server 3.

The able-to-log-in apparatus list EL3 is different from the apparatus list managed by the gateway device in that it does not record information of an apparatus having no sub-ID, and that it does not record the address of each apparatus (IP address).

Specifically, as shown in FIG. 6, the able-to-log-in apparatus list EL3 includes an apparatus name record portion R1′, a sub-ID record portion R2′, a sub-type record portion R3′, and a status record portion R4′.

The apparatus name record portion R1′, the sub-ID record portion R2′, the sub-type record portion R3′, and the status record portion R4′ record the same or similar contents as the apparatus name record portion R1, the sub-ID record portion R3, the sub-type record portion R4, and the status record portion R5 of the apparatus list, respectively. Therefore, detailed description thereof is omitted.

Hereinafter, an operation of the communication system 100 according to the first preferred embodiment is described. First, an outline of operation of the communication system 100 is described. When the terminal and the apparatus included in the communication system 100 communicate with each other, a communication session is established between the terminal and the apparatus.

Specifically, when performing video chat communication between the user terminals 5, the relay server 3 establishes a communication session between the user terminals 5, and the video chat communication starts between the user terminals 5.

On the other hand, when viewing data acquired by the camera and/or sensor of the automated warehouse system 1 using the user terminal 5, the relay server 3 establishes a communication session between the user terminal 5 and the camera and/or sensor. Thus, if a communication session should be established between the camera and/or the sensor and the user terminal 5 but the camera and/or the sensor has not logged in to the relay server 3, the gateway device connected to the camera and/or sensor controls the camera and/or sensor to log in to the relay server 3 after receiving the log-in request signal from the relay server 3.

Furthermore, when performing maintenance of the apparatus of the automated warehouse system 1 using the maintenance terminal of the maintenance base 2, a communication session is established between the gateway device of the maintenance base and the gateway device of the automated warehouse system 1.

As described above, in performing communication between the terminal and the apparatus of the communication system 100, the gateway device is active, (i) when a communication session between the user terminal 5 and the camera and/or sensor of the automated warehouse system 1 are established, and (ii) when a communication session between the gateway devices is established.

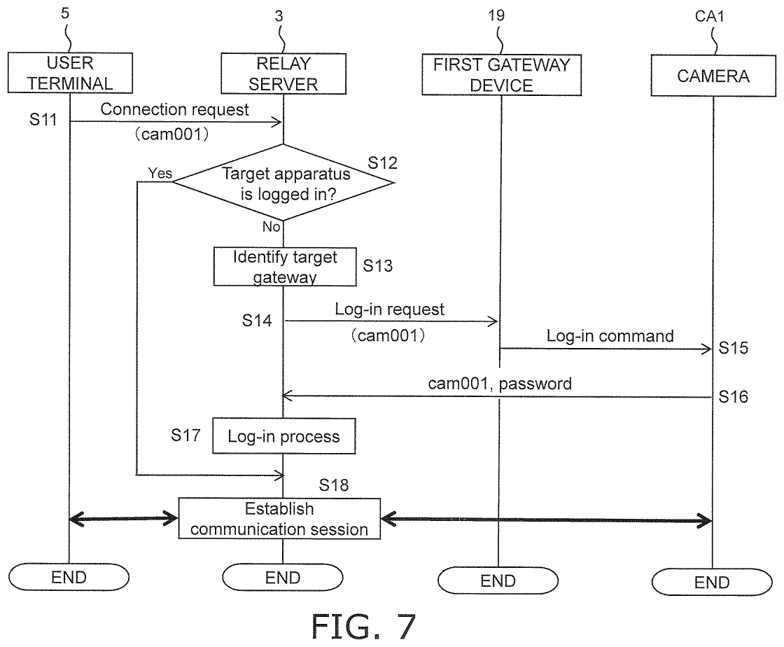

Accordingly, referring to FIG. 7, an operation when establishing a communication session between the user terminal 5 and the camera and/or sensor of the automated warehouse system 1 is first described. FIG. 7 is a flowchart showing an operation of establishing a communication session between the user terminal and the camera and/or sensor of the automated warehouse system.

Each process of the flowchart shown in FIG. 7 is performed when the controller defined by the processor 41, the RAM 42, and the like of the gateway device executes the program stored in the storage device 45.

Further, in the following, the process of establishing a communication session between the user terminal and the camera and/or sensor is described by exemplifying a case where the user terminal 5 that has logged in to the relay server 3 communicates with the camera CA1 (having sub-ID “cam001”) of the automated warehouse system 1.

When the user terminal 5 that has logged in to the relay server 3 accesses to the relay server 3, the relay server 3 receives the sub-ID and the sub-type of the camera and/or sensor to which the user terminal 5 is able to connect, from the able-to-log-in apparatus list EL3 described above, and sends the sub-ID and the sub-type of the camera and/or sensor as a device list to the user terminal 5.

The user terminal 5 that has received the device list displays the device list on a display. Accordingly, a user of the user terminal 5 is able to check which apparatus the user terminal 5 is able to communicate with.

When the user terminal 5 should communicate with the camera CA1, the user terminal 5 selects the sub-ID of the camera CA1 from the device list and sends a connection request including the sub-ID to the relay server 3, in Step S11.

In Step S12, the relay server 3 that has received the connection request described above determines whether or not the camera CA1 that is requested to connect to the user terminal 5 is logged in to the relay server 3. Specifically, the relay server 3 determines whether or not the log-in is performed using sub-ID “cam001” included in the connection request.

If the log-in is performed using sub-ID “cam001” (If “Yes” in Step S12), the communication session establishing process proceeds to Step S18.

On the other hand, if the log-in is not performed using this sub-ID (if “No” in Step S12), the communication session establishing process proceeds to Step S13.

In Step S13, the relay server 3 identifies the gateway device connected to the camera CA1 having sub-ID “cam001”. In the first preferred embodiment, the first gateway device 19 is identified as the gateway device connected to the camera CA1.

In Step S14, the relay server 3 sends the log-in request signal that controls the camera CA1 to log in to the relay server 3, to the identified first gateway device 19. It should be noted that this log-in request signal includes the sub-ID (cam001) of the apparatus (camera CA1) that is requested to connect to the user terminal 5. Accordingly, the first gateway device 19 is able to determine which connected apparatus should be controlled to log in.

In Step S15, the first gateway device 19 that has received the log-in request signal described above identifies that the apparatus that is requested to connect to the user terminal 5 is the camera CA1, from the sub-ID included in the log-in request signal. The first gateway device 19 sends a log-in command signal instructing to log in to the relay server 3, to the identified camera CA1.

It should be noted that if the status record portion R5 of the first apparatus list EL1 stored by the first gateway device 19 is “NG” in the row corresponding to the camera CA1, namely, if the camera CA1 is unable to communicate with the first gateway device 19, the first gateway device 19 may attempt to activate the camera CA1 using a “Wake On LAN” operation or the like, for example. After the first gateway device 19 communicates with the camera CA1, the first gateway device 19 may send the log-in command signal to the camera CA1.

Further, when the camera CA1 is activated and able to communicate with the first gateway device 19, the first gateway device 19 updates the first apparatus list EL1 by changing the status record portion R5 in the row corresponding to the camera CA1 from “NG” to “OK”.

In Step S16, the camera CA1 that has received the log-in command signal sends the sub-ID of the camera CA1 (cam001) and a password to log in to the relay server 3, to the relay server 3.

In Step S17, the relay server 3 that has received the sub-ID and the password performs a log-in process of the camera CA1 with sub-ID “cam001”.

After the camera CA1 is logged in successfully, or if it is determined in Step S12 that the camera CA1 is already logged in, in Step S18, the relay server 3 establishes a communication session between the user terminal 5 and the camera CA1.

By performing Steps S11 to S18 described above, when the communication between the apparatus of the automated warehouse system 1 and the user terminal 5 is relayed by the relay server 3, the gateway device of the automated warehouse system 1 (the first gateway device 19) is able to control the identified apparatus (the camera CA1 in the above example) to log in to the relay server 3 in response to receiving the log-in request signal.

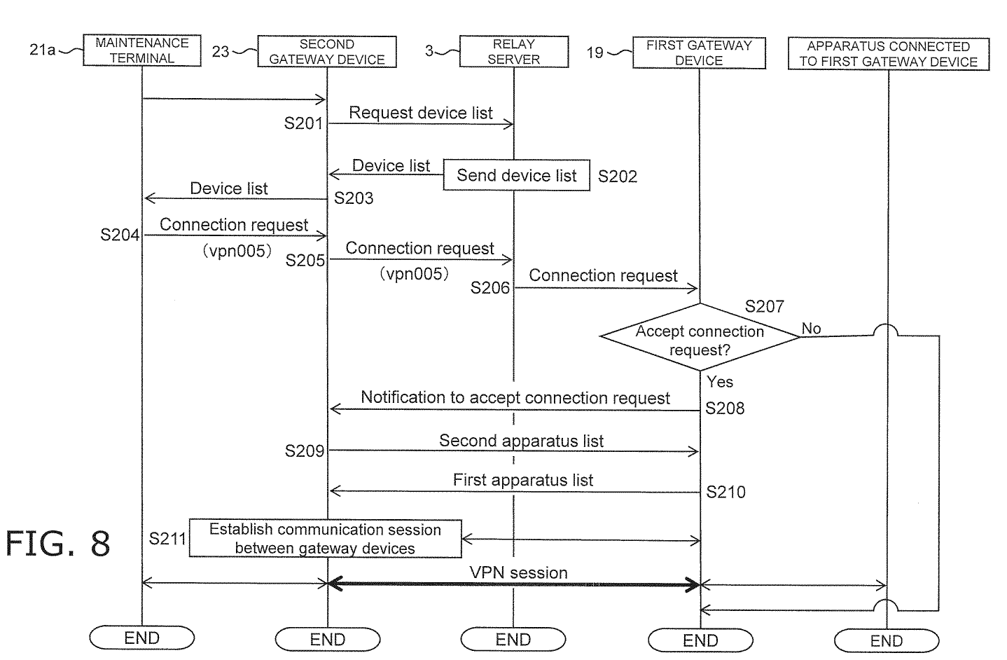

Next, a process of establishing a communication session between the gateway devices is described, referring to FIG. 8. FIG. 8 is a flowchart showing a process of establishing a communication session between the gateway devices.

The following description describes the process of establishing a communication session between the gateway devices by exemplifying a case where the second gateway device 23 of the maintenance base 2 sends the connection request to the first gateway device 19 of the automated warehouse system 1, and a communication session is established between the first gateway device 19 and the second gateway device 23.

For example, the maintenance terminal 21a executes maintenance application of the automated warehouse system 1, and the maintenance application sends the connection request to the gateway device of the automated warehouse system 1, to the second gateway device 23.

In Step S201, the second gateway device 23 sends a request to send the device list of other gateway devices to which the second gateway device 23 is able to connect, to the relay server 3.

In Step S202, the relay server 3 that has received the request generates the device list for the second gateway device 23 and sends the device list to the second gateway device 23.

In Step S203, the second gateway device 23 that has received the device list transfers the device list to the maintenance terminal 21a. Thus, the maintenance terminal 21a displays a list of other gateway devices to which the second gateway device 23 is able to connect.

When a user of the maintenance terminal 21a selects the user ID of the first gateway device 19, as a connection destination, from the device list, in Step S204, the maintenance terminal 21a sends the connection request including this user ID to the second gateway device 23.

In Step S205, the second gateway device 23 that has received the connection request sends this connection request to the relay server 3.

In Step S206, the relay server 3 that has received the connection request identifies the first gateway device 19 from the user ID included in the connection request, and sends the connection request to the first gateway device 19.

In Step S207, the first gateway device 19 that has received the connection request determines whether or not it accepts the connection request. If it is determined not to accept the connection request (if “No” in Step S207), the communication session establishing process ends without establishing a communication session between the first gateway device 19 and the second gateway device 23.

On the other hand, if it is determined to accept the connection request (if “Yes” in Step S207), in Step S208, the first gateway device 19 sends a notification of accepting the connection request to the second gateway device 23.

In Step S209, the second gateway device 23 that has received the notification sends the second apparatus list EL2 stored in itself to the first gateway device 19.

On the other hand, in Step S210, the first gateway device sends the first apparatus list EL1 stored in itself to the second gateway device 23. Thus, the second gateway device 23 may send the received first apparatus list EL1 to the maintenance terminal 21a.

By performing Steps S209 to S210 described above, the first gateway device 19 and the second gateway device 23 are able to exchange the apparatus lists.

After the apparatus lists are exchanged, in Step S211, a communication session (e.g. virtual private network (VPN) session) is established between the first gateway device 19 and the second gateway device 23.

By establishing a communication session between the first gateway device 19 and the second gateway device 23 as described above, the maintenance terminal 21a is able to access to every apparatus connected to the first gateway device 19 via the second gateway device 23 and the first gateway device 19.

In other words, the maintenance terminal 21a is able to access not only to the cameras CA1 to CA4 and the sensor SE of the automated warehouse system 1 but also to the first external storage device 13a, the second external storage device 13b, the conveyance management server 15, and the information management server 17.

Furthermore, the maintenance terminal 21a that is not able to log in to the relay server 3 is able to access not only to the apparatus that is able to log in to the relay server 3 of the automated warehouse system 1 but also to the apparatus that is not able to log in to the relay server 3.

Further, when the first gateway device 19 and the second gateway device 23 establish a communication session, they exchange the apparatus lists stored in them each other. Accordingly, the second gateway device 23 is able to determine the IP address of the apparatus that is connected to the first gateway device 19. Further, the first gateway device 19 is able to determine the IP address of the maintenance terminal 21a, 21b of the second gateway device 23.

As a result, the maintenance terminal 21a and the apparatuses of the automated warehouse system 1 are able to communicate with each other using the IP address known by the first gateway device 19 and the second gateway device 23.

Specifically, when the first gateway device 19 receives data directed to the IP address included in the first apparatus list EL1 from the second gateway device 23, the controller transfers the received data to the apparatus assigned with the address.

For example, in response to receiving data directed to IP address “192.168.0.21” from the maintenance terminal 21a, the second gateway device 23 transfers the received data directed to IP address “192.168.0.21” to the first gateway device 19. Thus, the data includes IP address of the maintenance terminal 21a (172.28.0.2) as a source.

The first gateway device 19 that has received the data identifies that the destination of the received data is the first external storage device 13a, from the IP address “192.168.0.21”, and sends the received data to the first external storage device 13a.

When the first external storage device 13a that has received the data sends a response to the source of data, it sends the response with the destination of IP address “172.28.0.2” that is the source address to the first gateway device 19. Accordingly, the response is sent to the maintenance terminal 21a via the first gateway device 19 and the second gateway device 23.

The gateway device of the first preferred embodiment responds to the instruction from the relay server 3 to perform, not only the process of controlling the apparatus connected to the gateway device to log in to the relay server 3 and the process of establishing a communication session with other gateway device, but also (i) the process of generating and sending the able-to-log-in apparatus list EL3, and (ii) the process of monitoring connection statuses of the apparatuses connected to the gateway device, and communicating with the relay server 3.

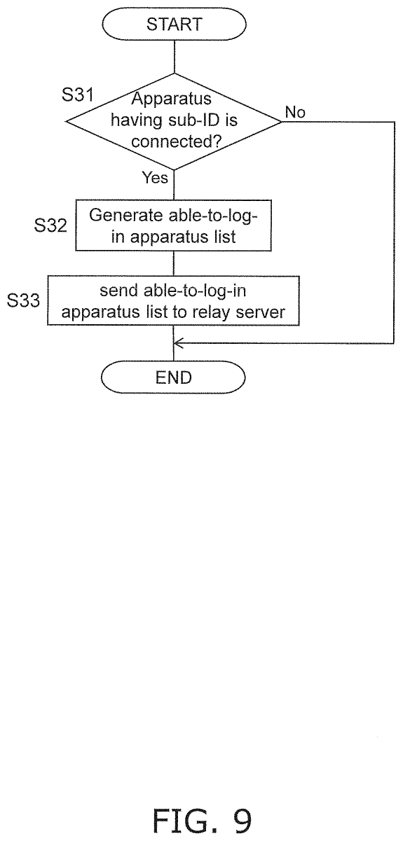

Hereinafter, the operations of the gateway device in these processes are described. First, the generating and sending process of the able-to-log-in apparatus list EL3 is described, referring to FIG. 9. FIG. 9 is a flowchart showing the generating and sending process of the able-to-log-in apparatus list.

This process is performed, for example, when the gateway device is installed in the communication system 100 for the first time, or when an apparatus connected to the gateway device is removed or added.

When the generating and sending process of the able-to-log-in apparatus list starts, in Step S31, the gateway device determines whether or not an apparatus having a sub-ID is connected to the gateway device.

Specifically, the gateway device refers to the apparatus list managed by the gateway device, and based on whether or not an apparatus whose information is recorded in the sub-ID record portion R3 exists, it determines whether or not an apparatus having a sub-ID is connected.

If the gateway device, for example, the second gateway device 23 of the first preferred embodiment, determines that the apparatus having a sub-ID is not connected to the gateway device (if “No” in Step S31), the gateway device ends the generating and sending process of the able-to-log-in apparatus list EL3 without generating the able-to-log-in apparatus list EL3.

On the other hand, if the gateway device, for example, the first gateway device 19 of the first preferred embodiment, determines that an apparatus having a sub-ID is connected to the gateway device (if “Yes” in Step S31), the generating and sending process of the able-to-log-in apparatus list EL3 proceeds to Step S32. Accordingly, the generating and sending of the able-to-log-in apparatus list EL3 is substantially performed by the gateway device connected to the apparatus having a sub-ID, and in the following description, the process executed in the first gateway device 19 is described as one example.

In Step S32, the first gateway device 19 extracts information described in a portion other than the address record portion R2 of the apparatus having a sub-ID, from the first apparatus list EL1 managed by the first gateway device 19, and generates the able-to-log-in apparatus list EL3 as shown in FIG. 6.

In Step S33, the first gateway device 19 sends the generated able-to-log-in apparatus list EL3 to the relay server 3.

By performing Steps S31 to S33 described above, the gateway device is able to transmit, to the relay server 3, information about the apparatus having a sub-ID connected to the gateway device (for example, the camera and/or sensor of the automated warehouse system 1).

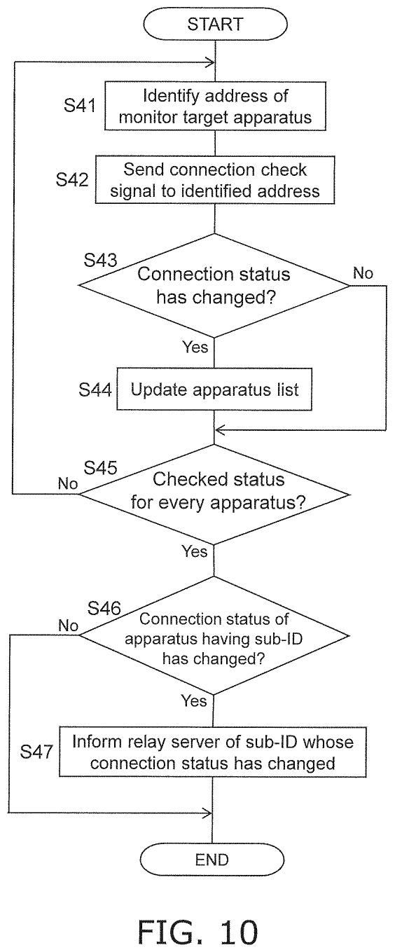

Hereinafter, a process of the gateway device in monitoring the connection status of each apparatus connected to the gateway device is described, referring to FIG. 10. FIG. 10 is a flowchart showing a process of monitoring the connection status of the apparatus.

This process is regularly performed every predetermined time, for example. Further, as described above, in the first preferred embodiment, the connection status of the maintenance terminal 21a, 21b of the maintenance base 2 is not monitored. Therefore, in the following description, a process of monitoring the connection status of each apparatus in the first gateway device 19 of the automated warehouse system 1 is described as one example.

When the monitoring of the connection status is started, in Step S41, the first gateway device 19 refers to the first apparatus list EL1 and identifies the IP address of the apparatus whose connection status should be monitored.

Next, in Step S42, the first gateway device 19 sends a connection check signal (for example, a ping signal) to the identified IP address.

After a predetermined time elapses from sending the connection check signal, in Step S43, the first gateway device 19 checks whether or not the connection status of the apparatus to which the connection check signal was sent is changed.

Specifically, when a response to the connection check signal is received from the apparatus, and the status record portion R5 of the first apparatus list EL1 is “NG” in the row corresponding to the apparatus, namely, the apparatus was unable to communicate with the first gateway device 19 in the last time of monitoring, the first gateway device 19 determines that the connection status of the apparatus is changed.

On the other hand, when no response to the connection check signal is received from the apparatus, and the status record portion R5 of the first apparatus list EL1 is “OK” in the row corresponding to the apparatus, namely, the apparatus was able to communicate with the first gateway device 19 in the last time of monitoring, the first gateway device 19 determines that the connection status of the apparatus is changed.

If it is determined that the connection status of the apparatus to which the connection check signal was sent is changed (if “Yes” in Step S43), the process of monitoring the connection status proceeds to Step S44.

On the other hand, if it is determined that the connection status of the apparatus to which the connection check signal was sent is not changed (if “No” in Step S43), the process of monitoring the connection status proceeds to Step S45.

In Step S44, the first gateway device 19 changes the status record portion R5 of the first apparatus list EL1 in the row corresponding to the apparatus whose connection status is changed, from “NG” to “OK” or vice versa. Accordingly, the most recent connection status of the apparatus may be provided in the first apparatus list EL1.

After checking the change in the connection status and describing the change in the first apparatus list EL1 for the apparatus to which the connection check signal was sent, if the change in the connection status is not checked for all apparatuses recorded in the first apparatus list EL1 (if “No” in Step S45), the process of monitoring the connection status of the apparatus returns to Step S41.

Accordingly, Steps S41 to S44 described above are repeatedly performed until the connection status is checked for all apparatuses recorded in the first apparatus list EL1.

After checking the change in the connection status for all apparatuses recorded in the first apparatus list EL1, if the connection status of the apparatus having a sub-ID recorded in the first apparatus list EL1 is changed (if “Yes” in Step S46), in Step S47, the first gateway device 19 extracts the sub-ID of the apparatus whose connection status is changed from the first apparatus list EL1, and sends a list of the extracted sub-IDs to the relay server 3.

By performing Steps S41 to S47 described above, the first gateway device 19 monitors the connection status of the apparatus connected to the network interface 44. If the connection status of the apparatus has changed, the relay server 3 is able to receive information regarding the change in the connection status.

In response to receiving the list of the sub-IDs whose connection status has changed, the relay server 3 changes the status record portion R4′ of the able-to-log-in apparatus list EL3 managed by the relay server 3 in the corresponding row. Accordingly, the relay server 3 is able to determine the most recent connection status of the apparatus connected to each gateway device in the able-to-log-in apparatus list EL3 managed by the relay server 3.

The first preferred embodiment may include the following structures and operations.

A gateway device (the first gateway device 19 or the second gateway device 23, for example) includes a network interface (the network interface 44, for example), a storage device (the storage device 45, for example), and a controller. The network interface connects to an apparatus (the camera CA1 to CA4 and/or sensor SE, for example), and performs communication with the apparatus and external communication. The storage device stores address information (the first apparatus list EL1, the second apparatus list EL2, for example). In the address information, an apparatus ID of the apparatus (the sub-ID, for example) and the address assigned to the apparatus are stored in association with each other.

When a connection request to the apparatus identified by the apparatus ID is received from a first external terminal (the user terminal 5, for example) via the network interface, the controller sends the connection request to the apparatus.

On the other hand, when the connection to the gateway device (the first gateway device 19, for example) is received from a second external terminal (the second gateway device 23, for example) via the network interface, the controller exchanges the address information with the second external terminal. In response to receiving data directed to an address included in the address information from the second external terminal, the controller transfers the received data to the apparatus assigned with the address.

When the gateway device described above receives the connection request to the apparatus identified by the apparatus ID from the first external terminal via the network interface, the gateway device sends the connection request to the apparatus. Accordingly, the apparatus connected to the network interface of the gateway device and the external terminal that has sent the connection request are able to directly send and receive data with one another.

On the other hand, when the gateway device receives the connection request to the gateway device from the second external terminal via the network interface, the gateway device exchanges the address information with the second external terminal. Accordingly, the second external terminal is able to determine the address of the apparatus connected to the gateway device. As a result, the second external terminal is able to communicate with the apparatus connected to the gateway device using the address included in the address information.

After exchanging the address information, the second external terminal sends data directed to an address included in the address information to the gateway device, and the gateway device that has received the data transfers the received data to the apparatus with which the address of a destination is assigned. Accordingly, also when a connection request is transmitted to the gateway device, the apparatus connected to the network interface of the gateway device and the second external terminal that has sent the connection request are able to send and receive data with one another.

Although the preferred embodiments of the present invention are described above, the present invention is not limited to the preferred embodiments described above but may be variously modified within the scope of the invention without deviating from the spirit thereof. In particular, the plurality of preferred embodiments and variations described in this specification may be combined with and/or modified in view of one another.

In the processes described in the first preferred embodiment with reference to the flowchart, the process of each step, the order of the steps, and the like may be modified within the scope of the present invention.

One gateway device is installed in one automated warehouse system 1 or maintenance base 2 in the first preferred embodiment, but this is not a limitation. A plurality of gateway devices may be installed in one automated warehouse system 1 or maintenance base 2. The number of the gateway devices is arbitrary according to, for example, the number of the cameras and/or sensors installed in the automated warehouse system 1, the number of the management servers of the automated warehouse system, and/or the number of the maintenance terminals of the maintenance base 2.

For example, if direct communication between the gateway devices is not possible due to setting of a firewall, a communication session between the two gateway devices may be established via the relay server 3. Thus, the relay server 3 may relay data transmission and reception between the two gateway devices.

A communication system includes a user terminal, a gateway device connected to an apparatus, and a relay server to relay communication between the user terminal and the apparatus. The gateway device includes a network interface connected to the apparatus to perform communication with the apparatus and external communication; a storage device to store address information in which an apparatus ID of the apparatus and an address assigned to the apparatus are stored in association with each other; and a controller. The controller is configured or programmed to, in response to receiving a connection request to the apparatus identified by the apparatus ID from a first external terminal via the network interface, send the connection request to the apparatus, in response to receiving a connection request to the gateway device from a second external terminal via the network interface, exchange the address information with the second external terminal, and in response to receiving data directed to an address included in the address information from the second external terminal, transfer the received data to the apparatus assigned with the address.

Preferred embodiments of the present invention may be widely applied to relay servers to relay communication between apparatuses included in a system.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-12. (canceled)

13. A gateway device to control communication between an apparatus with a predetermined operation and an external terminal to operate the apparatus in a communication system, the gateway device comprising:
a network interface connected to the apparatus to perform communication with the apparatus and external communication;
a storage device to store address information in which an apparatus ID of the apparatus and an address assigned to the apparatus are stored in association with each other; and
a controller configured or programmed to:
in response to receiving a connection request to the apparatus identified by the apparatus ID from a first external terminal via the network interface, send the connection request to the apparatus;
in response to receiving a connection request to the gateway device from a second external terminal via the network interface, exchange the address information with the second external terminal; and
in response to receiving data directed to an address included in the address information from the second external terminal, transfer the received data to the apparatus assigned with the address.

14. The gateway device according to claim 13, wherein
the connection request to the apparatus identified by the apparatus ID is a log-in request signal to control the apparatus to log in to a relay server to establish a communication session between the logged-in apparatus included in the communication system and the first external terminal; and
in response to receiving the log-in request signal, the controller is configured or programmed to control the identified apparatus to log in to the relay server.

15. The gateway device according to claim 14, wherein, if the identified apparatus is unable to communicate when the controller receives the log-in request signal, the controller is configured or programmed to attempt to activate the identified apparatus, and control the identified apparatus to log in to the relay server after the identified apparatus is activated.

16. The gateway device according to claim 14, wherein the controller is configured or programmed to monitor a connection status of the apparatus to the network interface, and when the connection status of the apparatus has changed, the controller is configured or programmed to transmit information regarding the change in the connection status to the relay server.

17. A communication system comprising an apparatus with a predetermined operation, an external terminal to operate the apparatus, and a first gateway device connected to the apparatus, the first gateway device including:
a network interface connected to the apparatus to perform communication with the apparatus and external communication;
a storage device to store first address information in which an apparatus ID of the apparatus and an address assigned to the apparatus are stored in association with each other; and
a controller configured or programmed to, in response to receiving a connection request to the apparatus identified by the apparatus ID from the external terminal via the network interface, send the connection request to the apparatus.

18. The communication system according to claim 17, further comprising:
a relay server to establish a communication session between the logged-in apparatus and the external terminal; wherein
the connection request to the apparatus identified by the apparatus ID is a log-in request signal to control the apparatus to log in to the relay server; and
in response to receiving the log-in request signal, the controller is configured or programmed to control the identified apparatus log in to the relay server.

19. The communication system according to claim 18, wherein, if the identified apparatus is unable to communicate in response to receiving the log-in request signal, the controller is configured or programmed to attempt to activate the identified apparatus, and control the identified apparatus log in to the relay server after the identified apparatus is activated.

20. The communication system according to claim 18, wherein the controller is configured or programmed to monitor a connection status of the apparatus to the network interface, and when the connection status of the apparatus has changed, the controller is configured or programmed to transmit information regarding the change in the connection status to the relay server.

21. The communication system according to claim 18, further comprising:
a second gateway device connected to a maintenance terminal to perform maintenance of the apparatus; wherein
in response to receiving a connection request to the first gateway device from the maintenance terminal via the second gateway device, the controller is configured or programmed to exchange the first address information with the second gateway device; and
in response to receiving data directed to an address included in the first address information from the maintenance terminal via the second gateway device, the controller is configured or programmed to transfer the received data to the apparatus assigned with the address.

22. The communication system according to claim 21, wherein the second gateway device is configured or programmed to store a second address information storing an address assigned to the maintenance terminal, and exchange the second address information with the first gateway device when exchanging the first address information with the first gateway device.

23. The communication system according to claim 18, further comprising:
an automated warehouse to load and unload, transfer, and store parcels; wherein
the apparatus is a monitoring apparatus installed in the automated warehouse to monitor a status of the automated warehouse.

24. An automated warehouse system comprising:
an automated warehouse to load and unload, transfer, and store parcels;
a monitoring apparatus installed in the automated warehouse to monitor a status of the automated warehouse; and
a gateway device connected to the monitoring apparatus, the gateway device including:
a network interface connected to the monitoring apparatus to perform communication with the monitoring apparatus and external communication;
a storage device to store address information in which an apparatus ID of the monitoring apparatus and an address assigned to the monitoring apparatus are stored in association with each other; and
a controller configured or programmed to:
in response to receiving a connection request to the monitoring apparatus identified by the apparatus ID via the network interface, send the connection request to the monitoring apparatus; and
in response to receiving data directed to an address included in the address information, transfer the received data to the monitoring apparatus assigned with the address.
